(19) United States
(12) Patent Application Publication
(10) Pub. No.: US 2024/0077260 A1
(43) Pub. Date: Mar. 7, 2024

(54) FRICTION ENERGY SYSTEMS

(71) Applicant: Rosemount Aerospace Inc., Burnsville, MN (US)

(72) Inventors: Vincent R. LoPresto, Eagan, MN (US); Brian Daniel Matheis, Lakeville, MN (US)

(73) Assignee: Rosemount Aerospace Inc., Burnsville, MN (US)

(21) Appl. No.: 18/201,051

(22) Filed: May 23, 2023

Related U.S. Application Data
(63) Continuation of application No. 16/441,876, filed on Jun. 14, 2019, now abandoned.

(51) Int. Cl. F28D 20/02; B64D 15/02; B64D 27/02

(52) U.S. Cl. CPC F28D 20/02; B64D 15/02; B64D 27/02

(57) ABSTRACT

An aerodynamic friction energy deicing system can include a heat energy device configured to be operatively connected to an aircraft structure and to convert heat energy due to aerodynamic friction on the aircraft structure into another form or to store heat energy due to aerodynamic friction on the aircraft structure. The converted or stored energy can be used for any suitable purpose, e.g., for use in ice prevention and/or deicing and/or powering one or more aircraft systems.

### CROSS-REFERENCE TO RELATED APPLICATIONS

This application is a continuation of U.S. patent application Ser. No. 16/441,876, filed Jun. 14, 2019, the entire content of which is incorporated herein by reference.

### BACKGROUND

### 1. Field

This disclosure relates to energy conversion systems, e.g., for powering an aircraft system and/or deicing aircraft structures.

### 2. Description of Related Art

Ice protection systems used in typical subsonic aircraft fall primarily into one of five categories. The first category includes systems that use hot bleed air from the engine compressor section and blow it against the region that needs to be protected against ice accretion. The second category includes systems that use electrical heating mats to protect critical areas against ice accretion. The third category includes inflatable rubber “boots” mounted on the outside of the area of the aircraft to be protected such that when the boot is inflated, the ice is cracked off. The fourth category includes electro-mechanical systems that shock the surface of interest to “knock” the ice off. All of these types of systems need power from the aircraft engines in order to perform their function. The fifth category includes freezing point depression systems that apply a chemical/fluid to the leading edge to decrease the freezing point of water.

Such conventional methods and systems have generally been considered satisfactory for their intended purpose. However, there is a need in the art for improved deicing systems, e.g., that can reduce weight and/or power draw for use with high-speed vehicles. The present disclosure provides a solution for this need.

### SUMMARY

In accordance with at least one aspect of this disclosure, an aerodynamic friction energy deicing system can include a heat energy device configured to be operatively connected to an aircraft structure and to convert heat energy due to aerodynamic friction on the aircraft structure into another form or to store heat energy due to aerodynamic friction on the aircraft structure. The converted or stored energy can be used for any suitable purpose, e.g., for use in ice prevention and/or deicing and/or powering one or more aircraft systems.

The system can include the aircraft structure. The aircraft structure can include, for example, at least one of a leading edge of a wing, a leading edge of a tail, a fuselage, a control surface, an instrument probe, or a windscreen.

The heat energy device can include a heat energy storage medium configured to store the heat energy as heat for later use. In certain embodiments, the heat energy storage medium can include a phase change material configured to receive heat due to aerodynamic friction and to change phase from a solid to a liquid as a result to store heat for later use in ice prevention and/or deicing. In certain embodiments, the heat energy storage medium can include at least one fluid circulating through the heat energy device including at least one of aircraft fuel, aircraft hydraulic fluid, aircraft coolant, aircraft refrigerant, or aircraft oil, or a dedicated energy storage fluid.

The heat energy device can include a thermoelectric generator configured to convert heat due to aerodynamic friction into electrical energy. An electrical storage device can be operatively connected to the thermoelectric generator to receive electrical energy therefrom. The system can include an electrical deicing system attached to a structure of an aircraft for receiving energy from the electrical storage device.

In accordance with at least one aspect of this disclosure, the system can be an aerodynamic friction energy generation system for providing electrical energy to an aircraft wherein the heat energy device can be configured to be operatively connected to an aircraft structure and to convert heat energy due to aerodynamic friction on the aircraft structure into electrical energy for use by an aircraft system. The aerodynamic friction energy generation system can include an electrical storage device operatively connected to the heat energy device to receive electrical energy therefrom.

In accordance with at least one aspect of this disclosure, a method can include receiving heat energy caused by aerodynamic friction on an aircraft structure, and storing the heat energy for later use. In certain embodiments, storing the heat energy can include storing the heat energy as heat. Storing the heat energy as heat can include storing the heat energy in a phase change material.

Storing the heat energy as heat can include storing the heat energy in an aircraft fluid. The aircraft fluid can include at least one of aircraft fuel, aircraft hydraulic fluid, aircraft coolant, aircraft refrigerant, or aircraft oil, or a dedicated energy storage fluid. The method can include using the stored heat or heat energy for preventing ice formation or deicing the aircraft structure.

In certain embodiments, storing the heat energy can include converting the heat energy into electrical energy and storing the electrical energy in an electrical storage device. The method can include using the stored electrical energy for preventing ice formation or deicing the aircraft structure. The method can include using the stored electrical energy to power an aircraft system (e.g., avionics, pumps, etc.).

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of a system in accordance with this disclosure;

FIG. 2 is a schematic view of a system in accordance with this disclosure; and

FIG. 3 is a schematic view of a system in accordance with this disclosure.

### DETAILED DESCRIPTION

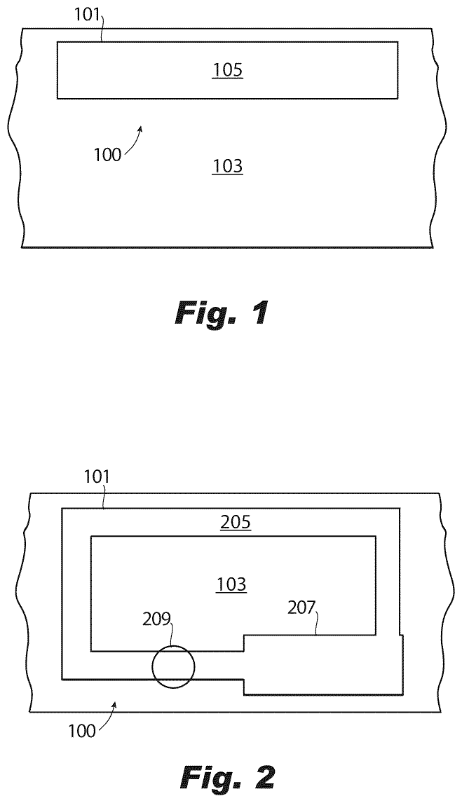

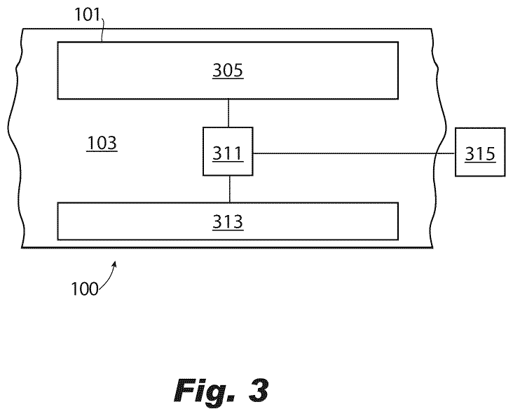

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2 and 3. Certain embodiments described herein can be used for, e.g., deicing and/or for energy production for any other use.

In accordance with at least one aspect of this disclosure, referring to FIGS. 1-3, an aerodynamic friction energy system 100 can include a heat energy device 101 configured to be operatively connected to an aircraft structure 103 and to convert heat energy due to friction on the aircraft structure 103 into another form (e.g., electrical energy) or to store heat energy (e.g., as heat or chemical energy) due to friction on the aircraft structure 103. The converted and/or stored energy can be used for any suitable purpose, e.g., for use in ice prevention and/or deicing and/or powering one or more aircraft systems. The system 100 can include the aircraft structure 103, for example.

The aircraft structure 103 can include at least one of a leading edge of a wing, a leading edge of a tail, a fuselage, a control surface, an instrument probe, or a windscreen. Any other suitable aircraft structure is contemplated herein.

As shown in FIG. 1, the heat energy device 101 can include a heat energy storage medium 105 configured to store the heat energy as heat for later use. In certain embodiments, the heat energy storage medium 105 can include a phase change material configured to receive heat due to friction and to change phase from a solid to a liquid as a result to store heat for later use, e.g., for ice prevention and/or deicing. As shown in FIG. 2, in certain embodiments, the heat energy storage medium 105 can include at least one fluid 205 circulating through the heat energy device 101 including at least one of aircraft fuel, aircraft hydraulic fluid, aircraft coolant, aircraft refrigerant, or aircraft oil, or a dedicated energy storage fluid (e.g., a fluid solely used for the heat energy device 101). The at least one fluid 205 can include a plurality of fluids in a fluidly separate circuit through the heat energy device 101, for example. The at least one fluid 205 can be from any suitable source, e.g., from a tank 207 circulated by pump 209, for example.

Referring to FIG. 3, the heat energy device 101 can include a thermoelectric generator 305 configured to convert heat due to friction into electrical energy. An electrical storage device 311 (e.g., a battery, a capacitor, etc.) can be operatively connected to the thermoelectric generator 305 to receive electrical energy therefrom. The system 100 can include an electrical deicing system 313 attached to a structure 103 of an aircraft for receiving energy from the electrical storage device 311, e.g., to provide deicing heat to the aircraft structure.

The system 100 can be an aerodynamic friction energy generation system for providing electrical energy to an aircraft. The heat energy device 101 can be configured to be operatively connected to an aircraft structure 103 and to convert heat energy due to aerodynamic friction on the aircraft structure 103 into electrical energy for use by an aircraft system, e.g., electrical deicing system 313 and/or avionics 315. The aerodynamic friction energy generation system 100 can include an electrical storage device 311 operatively connected to the heat energy device 101 to receive electrical energy therefrom.

In certain embodiments, the aircraft system can be an electrical deicing system 313. Any other suitable systems (e.g., aircraft avionics 315) are contemplated herein.

In accordance with at least one aspect of this disclosure, a method can include receiving heat energy caused by aerodynamic friction on an aircraft structure, and storing the heat energy for later use. In certain embodiments, storing the heat energy can include storing the heat energy as heat. Storing the heat energy as heat can include storing the heat energy in a phase change material.

Storing the heat energy as heat can include storing the heat energy in an aircraft fluid or a fluid dedicated to this purpose. The aircraft fluid can include at least one of aircraft fuel, aircraft hydraulic fluid, aircraft coolant, aircraft refrigerant, or aircraft oil, or a dedicated energy storage fluid. The method can include using the stored heat or heat energy for preventing ice formation or deicing the aircraft structure.

In certain embodiments, storing the heat energy can include converting the heat energy into electrical energy and storing the electrical energy in an electrical storage device. The method can include using the stored electrical energy for preventing ice formation or deicing the aircraft structure. The method can include using the stored electrical energy to power an aircraft system (e.g., one or more of avionics, pumps, etc.).

Embodiments include using the heat generated by skin friction of a high speed aircraft (e.g., supersonic or hypersonic aircraft) to perform ice protection. Instead of actively powering an ice protection system, embodiments can store the heat generated by the kinetic energy of the speed of flight through the atmosphere to be used later in the flight when at lower speeds and lower altitudes in icing conditions, for example. Depending on the time spent in icing and the severity of the icing conditions, certain embodiments could either be the sole means of ice protection or can act as partial or supplemental ice protection to reduce the burden on an active system or power requirements on an engine, for example. Embodiments can include a variety of methods to store the heat for use later, e.g., including using phase-change materials (e.g., a solid that turns into liquid when heated, then resists freezing to provide deicing), storing in an existing fluid used on the aircraft for other purposes (e.g., hydraulic, fuel, or water), or conversion of heat energy to other forms, e.g., electrical. While energy can be stored for later use, certain embodiments can be used to actively power electronics or other aircraft systems in high speed flight, e.g., in a primary electrical generator failure. Embodiments can reduce the overall size and/or weight of deicing systems, for example.

Embodiments can leverage the unique aspects of high speed vehicles (e.g., supersonic or hypersonic) to provide ice protection more efficiently than aircraft that fly at lower speeds. High-speed aircraft can accelerate and climb so quickly on takeoff that exposure to icing conditions may be limited enough to enable a passive means of dealing with any ice accretion (such as a wing design robust to such minimal accretion) during that flight phase. However, it is more likely that these vehicles will spend a significant amount of time in icing conditions during descent, approach, and landing. These phases of flight are often most critical for icing because the engines are at low power and it can be difficult to generate enough ice protection energy without increasing thrust to unacceptable levels, for example.

Using the heat energy that is unavoidably created by flying at high speeds as a source for ice protection either eliminates or reduces the need to burden the engines with creating that power for ice protection. In addition, depending on the implementation of the energy storage system it is possible to eliminate bleed air lines or electrical power distribution for an ice protection system.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. An aerodynamic friction energy system, comprising:
a heat energy device configured to be operatively connected to an aircraft structure and to convert heat energy due to aerodynamic friction on the aircraft structure into another form or to store heat energy due to friction on the aircraft structure,
wherein the system is configured for use in ice prevention and/or deicing such that the another form of energy of the stored heat energy is used to heat the aircraft structure to prevent icing or to deice,
wherein the heat energy device includes a heat energy storage medium configured to store the heat energy as heat for later use, wherein the heat energy storage medium includes a phase change material configured to receive heat due to friction and to change phase from a solid to a liquid as a result to store heat for later use in ice prevention and/or deicing, wherein the heat energy storage medium includes at least one fluid circulating through the heat energy device including at least one of aircraft fuel, aircraft hydraulic fluid, aircraft coolant, aircraft refrigerant, aircraft oil, or a dedicated energy storage fluid,
wherein the heat energy device includes a thermoelectric generator configured to convert heat due to friction into electrical energy;
an electrical storage device operatively connected to the thermoelectric generator to receive electrical energy therefrom; and
an electrical deicing system attached to a structure of an aircraft for receiving energy from the electrical storage device.

2. The system of claim 1, wherein the aircraft structure includes at least one of a leading edge of a wing, a leading edge of a tail, a fuselage, a control surface, an instrument probe, or a windscreen.

3. A system, comprising:
an aircraft structure,
an aerodynamic friction energy system of operatively connected to the aircraft structure, wherein the aerodynamic friction energy system includes:
a heat energy device configured to convert heat energy due to aerodynamic friction on the aircraft structure into another form or to store heat energy due to friction on the aircraft structure, wherein the system is configured for use in ice prevention and/or deicing such that the another form of energy of the stored heat energy is used to heat the aircraft structure to prevent icing or to deice,
wherein the heat energy device includes:
a heat energy storage medium including a phase change material configured to receive heat due to friction and to change phase from a solid to a liquid as a result to store heat for later use in ice prevention and/or deicing; and
a thermoelectric generator configured to convert heat due to friction into electrical energy;
an electrical storage device operatively connected to the thermoelectric generator to receive electrical energy therefrom; and
an electrical deicing system operatively connected to the aircraft structure for receiving energy from the electrical storage device.

4. The system of claim 3, wherein the heat energy storage medium includes at least one fluid circulating through the heat energy device.

5. The system of claim 4, wherein the at least one fluid includes: aircraft fuel, aircraft hydraulic fluid, aircraft coolant, aircraft refrigerant, aircraft oil, or a dedicated energy storage fluid.

6. The system of claim 4, wherein the heat energy storage medium includes a plurality of fluids in a fluidly separate circuit through the heat energy device.

7. The system of claim 3, wherein the electrical storage device includes a battery or a capacitor.

8. The system of claim 3, further comprising an aircraft electrical system operatively connected to the thermoelectric generator or the electrical storage device.

9. The system of claim 8, wherein the aircraft electrical system includes avionics.

10. A method, comprising:
receiving heat energy caused by aerodynamic friction on an aircraft structure; and
storing the heat energy for later use heating the aircraft structure, wherein storing the heat energy includes storing the heat energy as heat, wherein storing the heat energy as heat includes storing the heat energy in a phase change material;
using the stored heat energy for preventing ice formation or deicing the aircraft structure; and
using the stored heat for preventing ice formation or deicing the aircraft structure.

11. The method of claim 10, wherein storing the heat energy as heat includes storing the heat energy in an aircraft fluid.

12. The method of claim 11, wherein the aircraft fluid includes at least one of aircraft fuel, aircraft hydraulic fluid, aircraft coolant, aircraft refrigerant, or aircraft oil, or a dedicated energy storage fluid.

13. The method of claim 10, wherein storing the heat energy includes converting the heat energy into electrical energy and storing the electrical energy in an electrical storage device.

14. The method of claim 13, wherein storing the heat energy includes converting the heat energy into electrical energy and powering one or more electrical systems with the electrical energy.

15. The method of claim 14, wherein the one or more electrical systems include aircraft avionics and/or pumps.
